(19) United States
(12) Patent Application Publication
(10) Pub. No.: US 2013/0272654 A1
(43) Pub. Date: Oct. 17, 2013

(54) MULTI-DIRECTIONAL OPTICAL CONNECTOR

(71) Applicant: YU-CHAO HSIAO, Tu-Cheng (TW)

(72) Inventor: YU-CHAO HSIAO, Tu-Cheng (TW)

(73) Assignee: HON HAI PRECISION INDUSTRY CO., LTD., Tu-Cheng (TW)

(21) Appl. No.: 13/565,772

(22) Filed: Aug. 2, 2012

(30) Foreign Application Priority Data
Apr. 17, 2012 (TW) 101113566

(51) Int. Cl. G02B 6/32

(52) U.S. Cl. 385/33

(57) ABSTRACT

A multi-directional optical connector includes a main body and pairs of lenses arranged on the main body. The main body and the lenses are made of transparent material. The lenses in each pair are coaxial with each other. Different pairs of lenses are arranged along different directions.

### BACKGROUND

1. Technical Field

The present disclosure relates to a multi-directional optical connector.

2. Description of Related Art

Optical connectors are widely used in light emitting/receiving modules, light coupling modules, etc. An optical connector usually can only transmit light signals along a particular direction. Thus, when there is a need to transmit light signals along multiple directions, a number of optical connectors are needed, which is expensive.

Therefore, an optical connector which can overcome the above-mentioned problems is needed.

### BRIEF DESCRIPTION OF THE DRAWINGS

FIG. 1 is an isometric and schematic view of a multi-directional optical connector according to a first embodiment.

FIG. 2 is a front view of the multi-directional optical connector of FIG. 1.

FIG. 3 is an isometric and schematic view of a multi-directional optical connector according to a second embodiment.

FIG. 4 is a bottom view of the multi-directional optical connector of FIG. 3.

### DETAILED DESCRIPTION

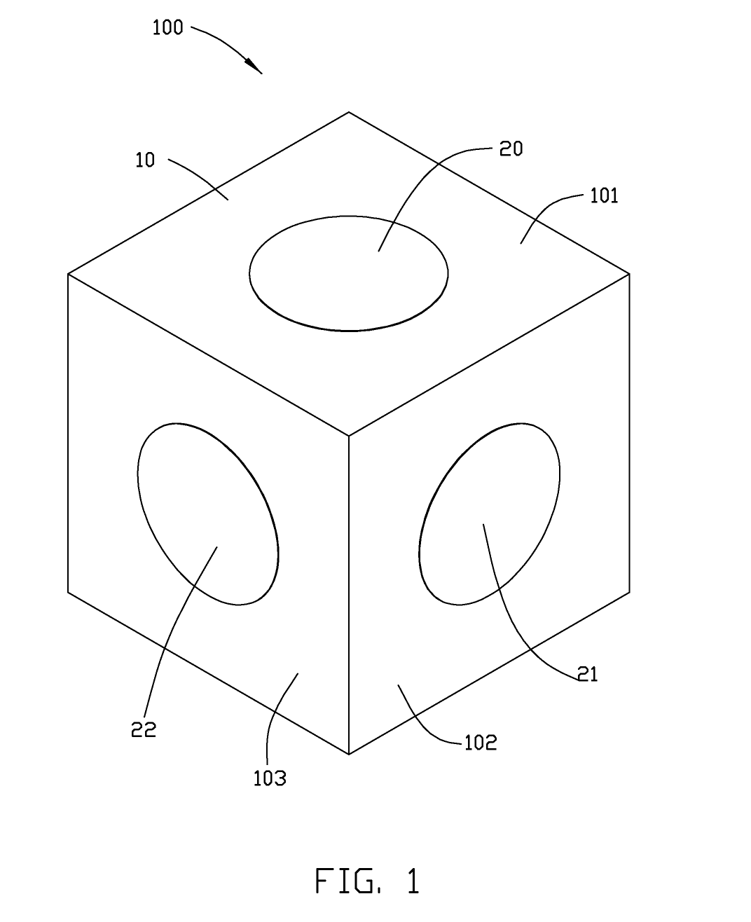

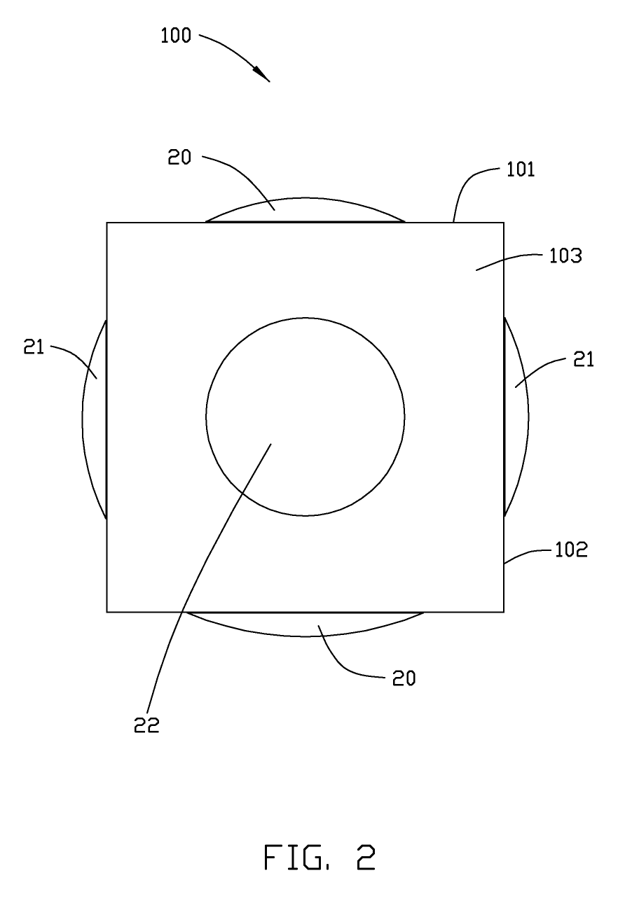

Referring to FIGS. 1 and 2, a multi-directional optical connector 100 according to a first embodiment includes a main body 10, a pair of first convex lenses 20, a pair of second convex lenses 21, and a pair of third convex lenses 22. The main body 10 is cubical, and includes two opposite first surfaces 101, two opposite second surfaces 102, and two opposite third surfaces 103 connected to each other. The first lenses 20 are coaxially arranged on the two first surfaces 101 respectively. The second lenses 21 are coaxially arranged on the two second surfaces 102 respectively. The third lenses 22 are coaxially arranged on the two third surfaces 103 respectively.

The main body 10, the first lenses 20, the second lenses 21, and the third lenses 22 are made of transparent material and are integrally formed. In this embodiment, the transparent material is acrylic.

In use, the first lenses 20 transmit first optical signals along a first direction, the second lenses 21 transmit second optical signals along a second direction, and the third lenses 22 transmit third optical signals along a third direction. The first optical signals, the second optical signals, and the third optical signals have different wavelengths mutual interference.

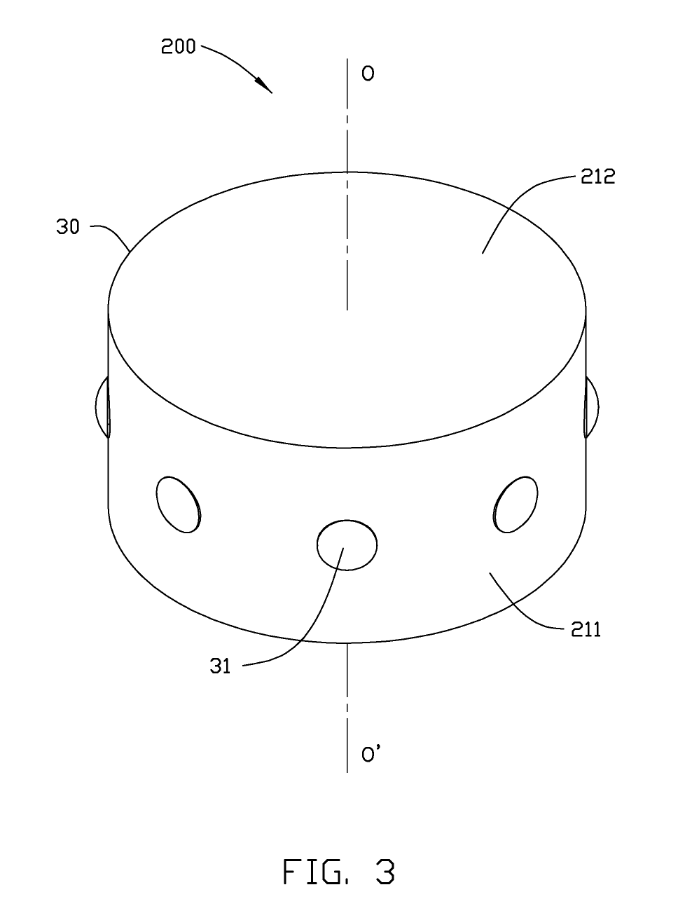

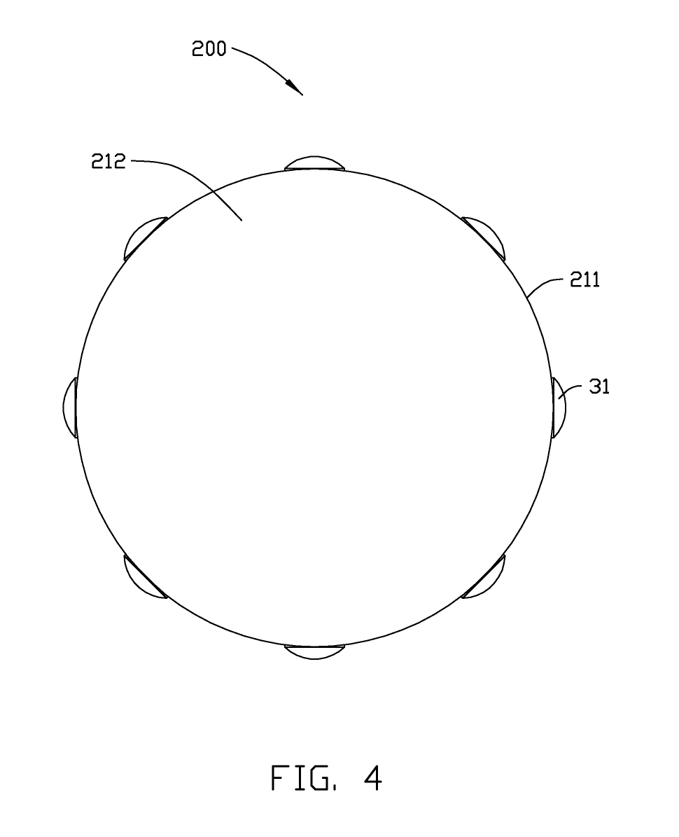

Referring to FIGS. 3 and 4, a multi-directional optical connector 200 according to a second embodiment includes a main body 30 and multiple pairs of convex lenses 31. The main body 30 is a cylinder. The main body 30 includes a cylindrical surface 211 and two opposite end surfaces 212. The multiple pairs of lenses 31 are arranged on the cylindrical surface 211 and evenly spaced apart. The lenses 31 in each pair are optically aligned with each other. An optical axis of each pair of lenses 31 is perpendicular to and intersects the central axis OO′ of the main body 30.

The optical connector has multiple pair of lenses arranged at different directions, thus, only one optical connector is needed for transmitting optical signals in different directions.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A multi-directional optical connector, comprising:
a main body; and
a plurality of pairs of lenses arranged on the main body, wherein the main body and the lenses are made of transparent material, the lenses in each pair are coaxially arranged, and different pairs of lenses are arranged along different directions.

2. The multi-directional optical connector of claim 1, wherein the main body and the lenses are integrally formed with each other.

3. The multi-directional optical connector of claim 1, wherein the main body and the lenses are made of acrylic.

4. The multi-directional optical connector of claim 1, wherein the main body is a cube and comprises two opposite first surfaces, two opposite second surfaces, and two opposite third surfaces, the lenses comprises a pair of first lenses arranged on the two first surfaces, a pair of second lenses arranged on the two second surfaces, and a pair of third lenses arranged on the two third surfaces.

5. The multi-directional optical connector of claim 1, wherein the main body is a cylinder and comprises a cylindrical surface and two opposite end surfaces connected to the cylindrical surface, the main body defines a central axis, the lenses are arranged on the cylindrical surface, an optical axis of each pair of lenses intersects the central axis.
